(19) United States
(12) Patent Application Publication
(10) Pub. No.: US 2007/0190872 A1
(43) Pub. Date: Aug. 16, 2007

(54) Fire retardant silicone textile coating

(76) Inventors: Robert F. Weber, Acworth, GA (US); Michael Zagryn, Atlanta, GA (US)

Correspondence Address: CONLEY ROSE, P.C., 5700 GRANITE PARKWAY, SUITE 330, PLANO, TX, 75024, US

(21) Appl. No.: 11/356,404

(22) Filed: Feb. 16, 2006

(51) Int. Cl. B32B 5/02

(52) U.S. Cl. 442/59

(57) ABSTRACT

A fire retardant (FR) textile coating comprising a plurality of FR agents, wherein the FR textile coating has a temperature dependent response to a fire or heat. The invention includes a fire resistant textile product comprising a textile substrate and a fire retardant textile coating comprising a plurality of FR agents, the coating absorbed into or adhered onto to the textile substrate. The invention also includes a method for making a fire resistant textile product, the method comprising preparing a fire retardant textile coating comprising a plurality of FR agents, applying the FR textile coating to a textile substrate, and curing the FR textile coating, thereby producing the fire resistant textile product. In an embodiment, the FR agents comprise a first FR agent that responds to a first temperature and a second FR agent that responds to a second temperature greater than the first temperature.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention is directed generally to fire retardant (FR) chemical compositions and, more specifically, to a silicone-based FR textile coating. The disclosed silicone based FR textile coating is wash durable, has a temperature-dependent response, and is useful in a variety of applications, including, but not limited to bedding, upholstery, vehicle and aircraft seats, apparel, appliances, insulation, ducting, fire safety gear, and the like.

### BACKGROUND

In several situations, it is desirable to make textile products fire resistant. One method for making textile products fire resistant is to apply a FR textile coating onto the otherwise flammable textile product. The FR textile coating makes the textile product fire resistant because the FR textile coating resists burning and in many cases helps extinguish existing fires by acting as a physical barrier between the fire and the fuel source, releasing oxygen depleting gases, or releasing water. The fire resistant textile products are advantageous over textile products lacking fire resistance in a variety of applications, including, but not limited to bedding, upholstery, vehicle and aircraft seats, apparel, appliances, insulation, ducting, fire safety gear, and the like.

Despite the reported employment of FR textile coatings in the past, there remains a need for FR textile coatings with improved properties.

### SUMMARY

In one aspect, the invention includes a FR textile coating comprising a plurality of FR agents, wherein the FR textile coating has a temperature dependent response to a fire or heat. In an embodiment, the FR textile coating further comprises a silicone binder. In another embodiment, a first FR agent is aluminum hydroxide and a second FR agent is magnesium hydroxide. In yet another embodiment, the FR textile coating comprises from about 1 percent by weight to about 35 percent by weight of the silicone binder, from about 10 percent by weight to about 25 percent by weight of the first FR agent, and from about 5 percent by weight to about 15 percent by weight of the second FR agent. The silicone binder may comprise organopolysiloxane silicone and dimethylpolysiloxane oil. In addition, the FR textile coating may comprise from about 5 percent by weight to about 15 percent by weight of the silicone binder, from about 30 percent by weight to about 50 percent by weight water, from about 10 percent by weight to about 25 percent by weight of the first FR agent, and from about 5 percent by weight to about 15 percent by weight of the second FR agent. Variously, the FR textile coating may further comprise an organic binder, optionally from about 1 percent by weight to about 8 percent by weight of the organic binder. The invention includes a fire resistant textile product comprising a textile substrate and the FR textile coating.

In a second aspect, the invention includes a fire resistant textile product comprising a textile substrate and a FR textile coating comprising a plurality of FR agents, the coating absorbed into or adhered onto to the textile substrate. In an embodiment, the FR agents comprise a first FR agent that responds to a first temperature and a second FR agent that responds to a second temperature greater than the first temperature. In another embodiment, the first FR agent is aluminum hydroxide and the second FR agent is magnesium hydroxide. In yet another embodiment, the FR textile coating further comprises a silicone binder. The FR textile coating may comprise from about 1 percent by weight to about 35 percent by weight of the silicone binder, from about 10 percent by weight to about 25 percent by weight of the first FR agent, and from about 5 percent by weight to about 15 percent by weight of the second FR agent. Alternatively, the FR textile coating may comprise from about 5 percent by weight to about 15 percent by weight of the silicone binder, from about 30 percent by weight to about 50 percent by weight water, from about 10 percent by weight to about 25 percent by weight of the first FR agent, and from about 5 percent by weight to about 15 percent by weight of the second FR agent. In addition, the FR textile coating may comprise from about 1 percent by weight to about 8 percent by weight of an organic binder.

In a third aspect, the invention includes a method for making a fire resistant textile product, the method comprising preparing a FR textile coating comprising a plurality of FR agents, applying the FR textile coating to a textile substrate, and curing the FR textile coating, thereby producing the fire resistant textile product. In an embodiment, the FR agents comprise a first FR agent that responds to a first temperature and a second FR agent that responds to a second temperature greater than the first temperature. In another embodiment, the applying step comprises roller coating the textile substrate with the FR textile coating. In yet another embodiment, the curing step comprises heating the FR textile coating.

### BRIEF DESCRIPTION OF THE DRAWINGS

For a more complete understanding of the present invention, and for further details and advantages thereof, reference is now made to the accompanying drawings, in which:

FIG. 1 is a cross-section view of one embodiment of a textile product containing the FR Silicone Textile Coating;

FIG. 2 is a block diagram of the process of applying the FR silicone textile coating to a textile substrate; and

FIG. 3 is a side view of one embodiment of a processing line for applying the FR Silicone Textile Coating to a textile substrate.

### DETAILED DESCRIPTION

A textile product having improved fire resistant properties is disclosed. The product can be made by selecting a textile suitable to receive the FR coating useful in the invention. A wide variety of textile substrates may be employed. The FR Silicone Textile Coating (described supra) is applicable to a variety of different textile substrates. Examples of suitable textile substrates include woven fabrics and nonwoven fiber batts. The textile substrates may contain natural fibers such as cotton, wool, or silk, may contain synthetic fibers such as rayon, nylon, polyester, polypropylene, or other polymeric fibers, or may contain a blend of natural and synthetic fibers. In an embodiment, the textile substrate is a woven textile substrate comprising a blend of cotton and polyester fibers.

It has been found that both natural and synthetic textile products coated with the FR Silicone Textile Coating are able to pass the pill test and are thus both flame resistant and wash durable. A surface flammability test (Consumer Products Safety Council standard FF-1-70) commonly referred to as the “pill test” is the surface flammability standard for flame resistant textiles. Briefly, the pill test involves exposing the textile product to an open flame and measuring the flame spread. When the flame spread does not exceed a threshold level, the textile product is considered to be fire resistant. A textile substrate coated with the FR Silicone Textile Coating is able to pass the pill test even after being laundered several times.

The FR Silicone Textile Coating comprises: a silicone binder, at least one FR agent, and optionally a catalyst, a char promoter, a filler, and various additives. In alternative embodiments, the FR Silicone Textile Coating further comprises water and/or an organic binder blended with the silicone binder. The silicone binder attaches the FR agent to the textile substrate may be any silicone-based material or a binder blend containing silicone-based materials. The use of the silicone binder is preferable because the silicone binder does not degrade the hand of the textile substrate to which it is applied. The silicone binder frequently improves the hand of the fibers to which it is applied. The FR Silicone Textile Coating imparts a rubbery or suede-like hand onto the textile product. Consumers prefer the rubbery or suede-like feel of the FR Silicone Textile Coating to the brittle, coarse, or flaky hand created by the prior art FR coatings. The silicone binder is not flammable and will not contribute to the combustion of the textile product. One suitable silicone binder is created by compounding organopolysiloxane silicone with dimethylpolysiloxane (DMS) oil. Specific examples of silicone binder suitable for use in the FR Silicone Textile Coating include: Silastic 9050/50PA available from Dow Corning, 1300 KT available from Sin Etsu, and Additive 85 available from Dow Corning. In various embodiments, the FR Silicone Textile Coating contains between about 0.1 percent and about 60 percent by weight, between about 1 percent and about 35 percent by weight, or between about 2 percent and about 10 percent by weight of the silicone binder.

The FR Silicone Textile Coating also comprises at least one FR agent. One example of a suitable FR agent is a metal hydrate. Metal hydrates are suitable FR agents because they utilize a plurality of different mechanisms to extinguish a fire. One mechanism used by metal hydrates to extinguish the fire is the dilution of the amount of fuel available to sustain the combustion. Metal hydrates and their decomposition products are not flammable, thus their inclusion in the FR Silicone Textile Coating reduces the amount of available fuel for the fire. In addition, metal hydrates contain a significant amount of water that is released when exposed to fire or heat, which limits the oxygen available for combustion. Another mechanism used by metal hydrates to extinguish a fire is heat absorption. Metal hydrates have a relatively high heat of vaporization, which allows the metal hydrate to absorb relatively high amount of heat from the fire and retard the growth of the fire. Some metal hydrates undergo endothermic decomposition, thus these metal hydrates are beneficial because they cool the fire and the surrounding textile substrate. A final mechanism used by metal hydrates to extinguish a fire is heat reflection. Several metal hydrates also generate heat reflective materials during combustion, which serve to deflect the fire's heat away from the unburned material. A variety of metal hydrates or other chemical compounds are suitable as FR agents. One example of a suitable FR agent is aluminum hydroxide. Aluminum hydroxide is also known as aluminum trihydrate (ATH), alumina hydroxide, and alumina trihydrate and generally has the chemical formula Al(OH)₃. When heated, aluminum hydroxide decomposes into alumina and water at about 200° C. Another suitable FR agent is magnesium hydroxide. Magnesium hydroxide is also known as magnesium hydrate and generally has the chemical formula Mg(OH)₂. When heated, magnesium hydroxide decomposes into magnesium oxide and water at about 325° C. By decomposing at about 325° C., magnesium hydroxide decomposes at a much higher temperature than the temperature at which aluminum hydroxide decomposes. Thus, the use of both aluminum hydroxide and magnesium hydroxide is preferable when creating the temperature dependent response of the FR Silicone Textile Coating because water is released at both 200° C. and 325° C.

Alternatively, the FR agent may be a variety of other chemical compounds. In other embodiments, the FR agent may be another metal hydrate or metal hydroxide, such as antimony hydroxide, zinc hydroxide, calcium hydroxide, ammonium molybdate tetrahydrate, barium hydroxide, ceric hydroxide, cesium hydroxide, nickel (II) hydroxide, and strontium hydroxide. The FR agent may also be an antimony compound, such as antimony trioxide, antimony hydrate, sodium antimonate, or antimony pentoxide. The FR agent may be a boron compound, such as zinc borate, boric acid, or borax. The FR agent may be another metal compound such as molybdenum trioxide, ammonium octa molybdate (AOM), zinc stannate, or zinc hydroxyl-stannate. The FR agent may be a char forming material, such as polyacylonitrile. The FR agent may be a phosphorus compound, such as red phosphorus or ammonium polyphosphate. The FR agent may be another inorganic flame retardant, such as ammonium sulfamate or ammonium bromide. The FR agent may be a halogenated organic compound, such as tetrabromobisphenol A, octabromobisphenyl ether, decabromodiphynyl ether, bis(tribromophenoxy) ethane, tetrabromobiphenyl ether, hexabromocyclododecane, tribromophenol, bis(tribromophenoxy) ethane, tetrabromobisphenol A polycarbonate oligomer, tetrabromobisphenol A epoxy oligomer, bis(hexacholorcyclopentadieno)cyclo-octane, or cholinated parrafins. The FR agent may be an organophosphorus compound, such as tris(1-chloro-2-propyl) phosphate, tris(2-chloroethyl) phosphate, tris(2,3-dibromopropyl) phosphate, trialkyl phosphate, triaryl phosphate, aryl-alkyl phosphate, FR polyols, phosphonium directivities, or phosphonates. The FR agent may also be a nitrogen-based chemical compound, such as polyurethanes, polyamides, melamine, or guanidine.

In various embodiments, the FR Silicone Textile Coating contains between about 1 percent and about 80 percent by weight, between about 10 percent and about 55 percent by weight, or between about 20 percent and about 40 percent by weight of the FR agents. In an embodiment, a plurality of FR agents are included in the FR Silicone Textile Coating to give the FR Silicone Textile Coating a temperature dependent response. In such embodiments, the FR Silicone Textile Coating contains between about 1 percent and about 60 percent by weight, between about 3 percent and about 40 percent by weight, or between about 4 percent and about 25 percent by weight of the first FR agent, and between about 0.1 percent and about 50 percent by weight, between about 1 percent and about 30 percent by weight, or between about 5 percent and about 15 percent by weight of second FR agent. In various embodiments, the second FR agent exists in the FR Silicone Textile Coating in combination with the first FR agent at a ratio of about 1 part second FR agent to: between about 0.1 part and about 10 parts first FR agent, between about 1 part and about 5 parts first FR agent, or between about 2 parts and about 4 parts first FR agent.

The FR Silicone Textile Coating may comprise a catalyst. Examples of a suitable catalysts are platinum and platinum-containing compounds. Specific examples of catalysts suitable for use with the FR Silicone Textile Coating include: Silastic 9050/50PB available from Dow Corning and Cat 1300 available from Shin Etsu. In various embodiments, the FR Silicone Textile Coating contains between about 0.01 percent and about 25 percent by weight, between about 0.1 percent and about 10 percent by weight, or between about 0.5 percent and about 5 percent by weight of the catalyst. Of course, the FR Silicone Textile Coating should not be limited to the catalysts described herein because persons of ordinary skill in the art are aware of catalysts other than those described herein that are suitable for use with the FR Silicone Textile Coating.

The FR Silicone Textile Coating may also comprise a char promoter. The char promoter promotes the formation of char by the FR agent and other components of the FR Silicone Textile Coating. On example of a suitable char promoter is polyvinyl chloride (PVC). In addition to acting as a char promoter, PVC in the form of a dispersion grade blending resin can also be used as a source of viscosity control and heat stability during processing. In various embodiments, the FR Silicone Textile Coating contains between about 0 percent and about 55 percent by weight, between about 1 percent and about 25 percent by weight, or between about 5 percent and about 15 percent by weight of the char promoter.

The FR Silicone Textile Coating optionally comprises a filler. The filler is a component that increases the volume of the FR Silicone Textile Coating without substantially reducing the fire resistance of a textile product containing the FR Silicone Textile Coating. Calcium carbonate is an example of suitable filler. Calcium carbonate is preferable because, in addition to be an inexpensive filler, it increases the FR properties of the FR Silicone Textile Coating. In various embodiments, the FR Silicone Textile Coating contains between about 0 percent and about 99 percent by weight, between about 10 percent and about 70 percent by weight, or between about 30 percent and about 50 percent by weight of the filler.

The FR Silicone Textile Coating may also optionally comprise one or more additives. One example of an additive which may be included is a colorant. Colorants, also called dyes or pigments, are added at a level so as to meet the aesthetic demands of the consumer. The colorant may be any color, including black, white, gray, brown, red, orange, yellow, green, blue, violet, or combinations thereof. Other suitable additives include: resins, plasticizers, odor absorbing agents, catalysts, processing aids, blowing agents, antimicrobial or antifungal compounds, antioxidants, and surfactants.

In an alternative embodiment, the FR Silicone Textile Coating further comprises water. Water is typically used with water soluble silicone binders to increase the control of the physical properties of the FR Silicone Textile Coating, make the FR Silicone Textile Coating more cost effective by decreasing the percent of silicone binder present in the FR Silicone Textile Coating, and increase the filler loading capacity of the FR Silicone Textile Coating. In various embodiments, the FR Silicone Textile Coating contains between about 0 percent and about 80 percent by weight, between about 20 percent and about 60 percent by weight, or between about 30 percent and about 50 percent by weight of the water.

In a further alternative embodiment, the FR Silicone Textile Coating further comprises an organic binder blended with the silicone binder. The organic binder can be included in the FR Silicone Textile Coating to promote the adhesion or absorption of the FR Silicone Textile Coating into or onto the textile substrate, increase the filler loading capacity of the FR Silicone Textile Coating, and/or decrease the cost of the binder. Due to the fact that some organic binders are flammable, the incorporation of the organic binder into the FR Silicone Textile Coating should be carefully monitored so that the FR Silicone Textile Coating imparts a suitable fire resistance upon the textile substrate. Suitable organic binders include: polyolefin elastomers (POE), vinyl latexes, acrylic latexes, styrene butadiene rubber (SBR), and natural latex rubber. In various embodiments, the FR Silicone Textile Coating contains between about 0 percent and about 50 percent by weight, between about 0.1 percent and about 20 percent by weight, or between about 1 percent and about 8 percent by weight of the organic binder.

The various components of the FR Silicone Textile Coating are mixed to complete dispersion and applied to the textile substrate to form the fire resistant textile product. Generally, the FR Silicone Textile Coating is applied onto the textile substrate such that the FR Silicone Textile Coating is absorbed into or adhered onto the textile substrate. The FR Silicone Textile Coating should be evenly applied to the textile substrate and cured if necessary. There are several application methods that are appropriate, some examples of which are described below.

FIG. 1 is a cross-section view of one embodiment of a fire resistant textile product containing the FR Silicone Textile Coating. The fire resistant textile product 100 comprises a textile substrate 102 comprising a plurality of fibers oriented randomly. The textile substrate 102 is coated with a FR Silicone Textile Coating 106 which makes the textile substrate 102 fire resistant. More specifically, the FR Silicone Textile Coating 106 is absorbed into or adhered onto the surface of the textile substrate 102. The FR Silicone Textile Coating 106 is curable using one of a variety of methods, including heat, infrared, ultraviolet light, and/or time. Once the FR Silicone Textile Coating 106 is cured, it is wash durable in that the FR Silicone Textile Coating 106 remains affixed to the textile substrate 102 when the textile product 100 is subjected to multiple launderings.

The fire resistant textile product utilizing the FR Silicone Textile Coating is sufficiently fire resistant that it is able to pass one or more fire resistance standards. Although the specific level of fire resistance depends on the specific formulation of the FR Silicone Textile Coating and the amount of FR Silicone Textile Coating applied to the textile substrate, the fire resistant textile product or another product incorporating the FR Silicone Textile Coating, such as a mattress, passes one or more flammability standards. Examples of these flammability standards include: California Technical Bulletin (TB) 117, 603, and 604, and 16 CFR 1610, 1611, 1615, 1616, 1630, 1631, 1632, 1633, and 1634.

In one embodiment, the FR Silicone Textile Coating is configured to provide a temperature dependent response when exposed to a fire. As used herein, a temperature dependent response means that the method by which the FR Silicone Textile Coating responds to the fire or heat source is dependent on the temperature of the FR Silicone Textile Coating. The temperature dependent response is preferable to the prior art FR compounds that have a single response temperature because the temperature dependent response allows the FR Silicone Textile Coating to perform a first extinguishing activity when the fire is small and thus the temperature is low, but still allows the FR Silicone Textile Coating to perform a second extinguishing activity when the fire grows, thereby causing the temperature of the FR Silicone Textile Coating to increase. When a fire spreads, the heat from the fire causes the combustible materials to become volatile and physically transform from a solid to a gas, either through sublimation or through melting and vaporization. The volatile gases produced by the combustible material are the materials that ignite and produce additional heat, thus propagating the fire. When a fire or other heat source heats the FR Silicone Textile Coating, the temperature of the FR Silicone Textile Coating rises to a first temperature at which a first FR agent performs a first extinguishing activity. More specifically, when the FR Silicone Textile Coating reaches the first temperature, the first FR agent performs one or more of the following extinguishing activities: producing char, releasing water, releasing oxygen depleting gases, causing or participating in an endothermic reaction, otherwise cooling the surrounding material, or otherwise attempting to extinguish the fire. If the fire or other heat source continues to heat the FR Silicone Textile Coating, the temperature of the FR Silicone Textile Coating will rise until it reaches a second temperature greater than the first temperature. When the FR Silicone Textile Coating reaches the second temperature, a second FR agent performs one or more of the following extinguishing activities: producing char, releasing water, releasing oxygen depleting gases, causing or participating in an endothermic reaction, otherwise cooling the surrounding material, or otherwise attempting to extinguish the fire. The second extinguishing activity performed by the second FR agent may be the same as, similar to, or partially or wholly different than the first extinguishing activity performed by the first FR agent. Moreover, the second extinguishing activity performed by the second FR agent may be the same as the first extinguishing activity performed by the first FR agent, but the level of response may be different. For example, the first FR agent may release a prescribed amount of water at the first temperature, but then the second FR agent may release a different amount of water at the second temperature. Thus, the response of the FR Silicone Textile Coating to the fire or heat source is dependent on the temperature of the FR Silicone Textile Coating; hence the FR Silicone Textile Coating has a temperature dependent response.

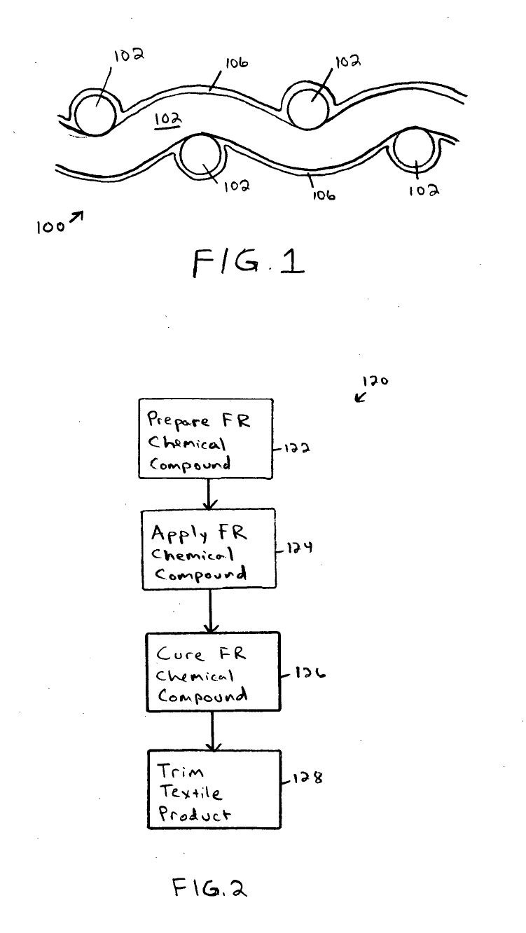

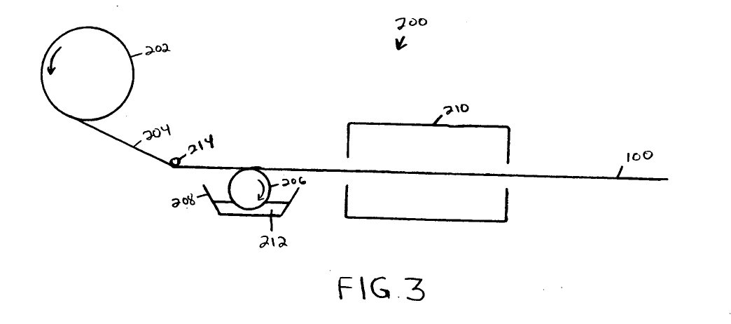

One method for making a fire resistant textile product will now be described in further detail. As seen in FIG. 2, method 120 for making the fire resistant textile product generally comprises: preparing the FR Silicone Textile Coating at 122, applying the FR Silicone Textile Coating to the textile substrate at 124, curing the FR Silicone Textile Coating, thereby forming the fire resistant textile product at 126, and trimming the fire resistant textile product at 128. Each of the steps of method 120 is described in further detail below.

At 122 of method 120, the FR Silicone Textile Coating is prepared by mixing the proper amount of components together to form a liquid resin. In one embodiment, the FR Silicone Textile Coating is prepared by first mixing the two components of the silicone binder, namely the organopolysiloxane silicone and the DMS oil. In various embodiments, the DMS oil has a kinematic viscosity between about 0.1 centistokes (cs) and about 2,000 cs, between about 2 cs and about 500 cs, or between about 20 cs and about 100 cs. In various embodiments, the DMS oil is added to the organopolysiloxane silicone in an amount to reduce the dynamic viscosity of the mixture to below about 30,000 cp, below about 10,000 cp, or below about 5,000 cp. The amount of DMS oil required to prepare the silicone binder is generally less than the amount of organopolysiloxane silicone, which allows for proper vulcanization of the silicone binder to occur. The catalyst is then added to the silicone binder in an amount that allows the FR Silicone Textile Coating to vulcanize at moderate temperatures and dwell times. In various embodiments, the vulcanization temperature is between about 150° F. to about 450° F., between about 250° F. to about 350° F., or between about 275° F. to about 325° F. In various embodiments, the dwell time is between about 5 seconds and about 15 minutes, between about 30 seconds and about 3 minutes, or between about 1 minute and about 2 minutes. The amount of catalyst added to the FR Silicone Textile Coating must be carefully monitored because an excessive amount of the catalyst will toughen the cured FR Silicone Textile Coating. The remaining FR Silicone Textile Coating components, including the FR agents, the char promoter, the filler, and the dyes, may then be added to the silicone binder and mixed until the FR Silicone Textile Coating is a homogenous mixture of the aforementioned components. Other preparation methods may be used as long as a homogenous mixture of the ingredients is achieved.

At 124 of method 120, the FR Silicone Textile Coating is applied to the textile using, for example, a roller coating process. In the roller coating process, the textile substrate is stretched between two holders or tenters and travels in a machine direction. The FR Silicone Textile Coating is located in a tray or trough below the textile substrate and a rotating roller is positioned between the textile substrate and the tray or trough such that the upper portion of the roller contacts the textile substrate and travels in the same direction as the textile substrate, while the lower portion of the roller becomes submerged in the FR Silicone Textile Coating. The FR Silicone Textile Coating clings to the surface of the roller as it rotates upward and is applied onto the textile substrate when the roller contacts the textile substrate. If desired, subsequent to the application of the FR Silicone Textile Coating onto the textile substrate, two doctor blades positioned above and below the coated textile substrate at a predetermined distance away from each other meter the amount of FR Silicone Textile Coating on the textile substrate by scraping off excess FR Silicone Textile Coating.

In another embodiment, the FR Silicone Textile Coating is applied to the textile using a dip and scrape process. In the dip and scrape process, the FR Silicone Textile Coating is located in a trough or tray and the textile substrate is routed through a plurality of rollers such that the textile substrate is immersed in the FR Silicone Textile Coating. When the textile substrate emerges from the FR Silicone Textile Coating, two doctor blades positioned on either side of the coated textile substrate at a predetermined distance away from each other meter the amount of FR Silicone Textile Coating on the textile substrate by scraping off excess FR Silicone Textile Coating. Other application methods may be suitable as long as they result in a product with the desired characteristics.

The amount of FR Silicone Textile Coating coated onto the textile substrate will vary depending on the desired application. In applications where a high degree of fire resistance is sought, such as fire blankets and firefighter turnout gear, an increased amount of FR Silicone Textile Coating should be applied onto the textile substrate. In applications where a lesser degree of fire resistance is required, such as bedclothes and human clothing, a lesser amount of FR Silicone Textile Coating can be applied onto the textile substrate. In various embodiments, the thickness of the FR Silicone Textile Coating coating on the textile substrate ranges from about 1 thousandth of an inch (mil) to about 350 mils, from about 50 mils to about 250 mils, or from about 70 mils to about 110 mils.

In other embodiments, the FR Silicone Textile Coating may be foamed prior to being applied to the textile substrate. In order for the FR Silicone Textile Coating to be foamed, air must be incorporated into the FR Silicone Textile Coating prior to application to the textile substrate. In one embodiment, air is incorporated into the FR Silicone Textile Coating by whipping or otherwise mechanically frothing the FR Silicone Textile Coating until the FR Silicone Textile Coating foam to the specified density. Plasticizers, blowing agents and/or other additives may be optionally included in the FR Silicone Textile Coating to improve the ability of the FR Silicone Textile Coating to form and maintain the foamed state. In an alternative embodiment, the FR Silicone Textile Coating may be foamed by incorporating a blowing agent into the FR Silicone Textile Coating. Generally, the blowing agent is activated by heat such that when the FR Silicone Textile Coating passes through an oven or other curing device, the blowing agent foams the FR Silicone Textile Coating at the same time the FR Silicone Textile Coating is curing. Alternatively, the blowing agent can be activated by some other means, such as exposure to radiation, radio frequency, ultraviolet, or infrared light. Other foaming methods may also be appropriate as long as they provide the appropriate density of the FR Silicone Textile Coating.

At 126 of method 120, the FR Silicone Textile Coating is cured, for example, using heat. In one embodiment, the FR Silicone Textile Coating is cured by passing the coated textile substrate though an oven. Alternatively, the FR Silicone Textile Coating can be cured using infrared or ultraviolet lamps. The FR Silicone Textile Coating can also be cured using radio frequency or can self-cure over time. The temperature and time required to cure the FR Silicone Textile Coating coated on the textile substrate will vary depending on the specific formulation of the FR Silicone Textile Coating, the type, denier, and weave of the fibers in the textile substrate, and the amount of FR Silicone Textile Coating coated onto the textile substrate. However, in various embodiments, the oven is configured to have a temperature range between about 150° F. and about 600° F., between about 300° F. and about 450° F., or between about 360° F. and about 390° F. If infrared lamps are used to cure the FR Silicone Textile Coating, in various embodiments the lamps have an intensity between about 0.5 and about 200 watts per square inch, between about 5 and about 50 watts per square inch, or between about 10 and about 20 watts per square inch. In various embodiments, the time required to cure the FR Silicone Textile Coating coated on the textile substrate is between about 2 seconds and 30 minutes, between about 30 seconds and about 15 minutes, or between about 1 minute and 5 minutes. Once the FR Silicone Textile Coating has been cured, the coated textile substrate is referred to as a fire resistant textile product.

At 128 of method 120, the fire resistant textile product may be trimmed to a desired size. In an embodiment, the trimming process generally comprises cutting the fire resistant textile product with a knife or other cutting instrument. The fire resistant textile product is generally cut widthwise into standardized lengths, such as 100 feet, 300 feet, or 1,000 feet. In some embodiments, it is also preferable to trim the edges off of the fire resistant textile product because the edges may contain uncoated substrate material, may contain frayed material, or may otherwise be undesirable. Furthermore, in some embodiments, it is also desirable to trim the fire resistant lengthwise into standardized widths, such as 1 foot, 3 foot, or 5 foot. The fire resistant textile product is then generally folded or rolled such that it is suitable for packaging and/or transportation.

FIG. 3 is a side view of one embodiment of a processing line 200 for implementing the coating and curing process described herein. The processing line 200 comprises a wound roll 202 of textile substrate 204, a roller 206, a trough 208, an oven 210, a guide roll 214, and the FR Silicone Textile Coating 212. The textile substrate 204 is unwound from the roll 202 and aligned with the oven 210 using one or more guide rolls 214. The processing line 200 uses the roller coating process described above to apply the FR Silicone Textile Coating 212 onto the textile substrate 204. As described above, the roller coating process uses the roller 206 to pick up some of the FR Silicone Textile Coating 212 from the trough 208 and coats the textile substrate 204 with the FR Silicone Textile Coating 212. The coated textile substrate 204 then passes through the oven to cure, as described above. After the coated textile substrate 204 is cured in the oven, it is referred to as the fire resistant textile product 100. The fire resistant textile product 100 may be used in a variety of applications, including, but not limited to bedding, upholstery, vehicle and aircraft seats, apparel, appliances, insulation, ducting, fire safety gear, and the like.

### EXAMPLES

In one embodiment, a FR Silicone Textile Coating was created using modified liquid rubber silicones (LRS). High viscosity LRS was blended with low viscosity dimethyl silicone (DMS) fluid. The combination allowed for the overall mixture viscosity to be reduced, thereby allowing for the addition of various FR agents, catalysts, and fillers. The formulation shown below in Table 1 demonstrates how an inherently FR binder can be used to affix solid state FR agents to a textile substrate.

TABLE 1

| Component | Component Examples | Parts | Percent |
|---|---|---|---|
| Silicone Binder | Dow Silastic 9050/50PA or Sin Etsu | 30 | 12 |
| | 1300-KT | | |
| Silicone Binder | Dow Corning 200 Fluid | 35 | 14 |
| FR Agent | Aluminum Hydroxide | 50 | 20 |
| FR Agent | Magnesium Hydroxide | 25 | 10 |
| FR Agent | Antimony Hydroxide | 7 | 3 |
| Catalyst | Dow Silastic 9050/50PB or Shin Etsu | 3 | 1 |
| | Cat1300 | | |
| Filler | Calcium Carbonate | 100 | 40 |

When the formulation shown in Table 1 was applied to cotton and/or polyester substrates, the resulting textile products were able to pass the pill test described above after five launderings and, as a result, were considered both wash durable and flame resistant. In addition, the hand of the textile was acceptable, exhibiting a slight rubbery feel with no evidence of coarseness, flaking, or brittleness.

In some applications, it is desirable to decrease the amount of silicone binder present in the formulation. Consequently, the LRS-DMS-catalyst combination shown in Table 1 was replaced with the water-based polyorganosilane emulsion shown in Table 2. The shift to a water based application not only allowed for improved filler capacity but also provided greater processing control of add-on weights via the percent solids variable.

TABLE 2

| Component | Component Examples | Parts | Percent |
|---|---|---|---|
| Silicone Binder | Dow Corning | 15 | 5 |
| | Additive 85 | | |
| Water | Water | 125 | 39 |
| FR Agent | Aluminum Hydroxide | 50 | 15 |
| FR Agent | Magnesium Hydroxide | 25 | 8 |
| FR Agent | Antimony Hydroxide | 7 | 2 |
| Filler | Calcium Carbonate | 100 | 31 |

When the formulation shown in Table 2 was applied to cotton and/or polyester substrates, the hand of the textile was acceptable. More specifically, the textile product exhibiting a suede-like feel and did not contain any evidence of coarseness, flaking, or brittleness.

In other applications, it is desirable to optimize the utilization of ingredients to achieve a desired performance. For example, although traditional olefin based binders have been shown to provide ideal costs and hand quality, FR performance suffers on the basis that a carbon backbone has been introduced and allowed to participate in combustion. However, a partial substitution of the inorganic silicone component with a traditional organic binder lowers the amount of required ingredients without a significant loss of fire resistance. Traditional carbon based binders may take the form of a polyolefin elastomers (POE), vinyl latexes, acrylic latexes, SBR or natural rubber, and the like. Table 3 is an example formula where a partial substitution of the inorganic component has been replaced with a traditional carbon based binder.

TABLE 3

| Component | Component Examples | Parts | Percent |
|---|---|---|---|
| Silicone Binder | Dow Corning Additive 85 | 10 | 3 |
| Organic Binder | Acrylic, Vinyl, SBR, Natural Rubber | 5 | 2 |
| | Latex or POE | | |
| Water | Water | 125 | 39 |
| FR Agent | Aluminum Hydroxide | 50 | 15 |
| FR Agent | Magnesium Hydroxide | 25 | 8 |
| FR Agent | Antimony Hydroxide | 7 | 2 |
| Filler | Calcium Carbonate | 100 | 31 |

When the formulation shown in Table 3 was applied to cotton and/or polyester substrates, the hand of the textile was acceptable. More specifically, the textile product exhibiting a suede-like feel and did not contain any evidence of coarseness, flaking, or brittleness.

While a number of preferred embodiments of the invention have been shown and described herein, modifications thereof may be made by one skilled in the art without departing from the spirit and the teachings of the invention. The examples described herein are exemplary only and are not intended to be limiting. Accordingly, the scope of protection is not limited by the description set out above, but is defined by the claims which follow, that scope including all equivalents of the subject matter of the claims.

1. A fire retardant textile coating comprising: a plurality of fire retardant agents; wherein the fire retardant textile coating has a temperature dependent response to a fire or heat.

2. The fire retardant textile coating of claim 1 further comprising a silicone binder.

3. The fire retardant textile coating of claim 2 wherein a first fire retardant agent is aluminum hydroxide and a second fire retardant agent is magnesium hydroxide.

4. The fire retardant textile coating of claim 3 comprising:
from about 1 percent by weight to about 35 percent by weight of the silicone binder;
from about 10 percent by weight to about 25 percent by weight of the first fire retardant agent; and
from about 5 percent by weight to about 15 percent by weight of the second fire retardant agent.

5. The fire retardant textile coating of claim 4 wherein the silicone binder comprises organopolysiloxane silicone and dimethylpolysiloxane oil.

6. The fire retardant textile coating of claim 3 comprising:
from about 5 percent by weight to about 15 percent by weight of the silicone binder;
from about 30 percent by weight to about 50 percent by weight water;
from about 10 percent by weight to about 25 percent by weight of the first fire retardant agent; and
from about 5 percent by weight to about 15 percent by weight of the second fire retardant agent.

7. The fire retardant textile coating of claim 6 further comprising an organic binder.

8. The fire retardant textile coating of claim 7 further comprising: from about 1 percent by weight to about 8 percent by weight of the organic binder.

9. A fire resistant textile product comprising: a textile substrate and the fire retardant textile coating of claim 1.

10. A fire resistant textile product comprising: a textile substrate and a fire retardant textile coating comprising a plurality of fire retardant agents, the coating absorbed into or adhered onto to the textile substrate.

11. The fire resistant textile product of claim 10 wherein the fire retardant agents comprise: a first fire retardant agent that responds to a first temperature and a second fire retardant agent that responds to a second temperature greater than the first temperature.

12. The fire resistant textile product of claim 11 wherein the first fire retardant agent is aluminum hydroxide and the second fire retardant agent is magnesium hydroxide.

13. The fire resistant textile product of claim 11 wherein the fire retardant textile coating further comprises a silicone binder.

14. The fire resistant textile product of claim 13 wherein the fire retardant textile coating comprises:
from about 1 percent by weight to about 35 percent by weight of the silicone binder;
from about 10 percent by weight to about 25 percent by weight of the first fire retardant agent; and
from about 5 percent by weight to about 15 percent by weight of the second fire retardant agent.

15. The fire resistant textile product of claim 13 wherein the fire retardant textile coating comprises:
from about 5 percent by weight to about 15 percent by weight of the silicone binder;
from about 30 percent by weight to about 50 percent by weight water;
from about 10 percent by weight to about 25 percent by weight of the first fire retardant agent; and
from about 5 percent by weight to about 15 percent by weight of the second fire retardant agent.

16. The fire resistant textile product of claim 15 wherein the fire retardant textile coating further comprises: from about 1 percent by weight to about 8 percent by weight of an organic binder.

17. A method for making a fire resistant textile product, the method comprising:
preparing a fire retardant textile coating comprising a plurality of fire retardant agents;
applying the fire retardant textile coating to a textile substrate; and
curing the fire retardant textile coating, thereby producing the fire resistant textile product.

18. The method of claim 17 wherein the fire retardant agents comprise: a first fire retardant agent that responds to a first temperature and a second fire retardant agent that responds to a second temperature greater than the first temperature.

19. The fire resistant textile product of claim 18 wherein the applying step comprises: roller coating the textile substrate with the fire retardant textile coating.

20. The fire resistant textile product of claim 19 wherein the curing step comprises: heating the fire retardant textile coating.
